(19) United States
(12) Patent Application Publication
(10) Pub. No.: US 2025/0006080 A1
(43) Pub. Date: Jan. 2, 2025

(54) SYSTEM AND METHOD RATING DRIVER PERFORMANCE, PROVIDING DRIVING COACHING FEEDBACK, AND MAKING DRIVING INCIDENT PREDICTIONS

(71) Applicant: RM ACQUISITION, LLC, Boise, ID (US)

(72) Inventors: Andreas U. KUEHNLE, Strangnas (SE); Andre TOKMAN, San Clemente, CA (US); Matthew G. LOMBARDI, Strongsville, OH (US); Shaun M. HOWARD, Irvine, CA (US)

(21) Appl. No.: 18/345,479

(22) Filed: Jun. 30, 2023

(51) Int. Cl. G09B 19/16; G06Q 10/0639

(52) U.S. Cl. CPC G09B 19/167; G06Q 10/06398; B60Q 9/00

(57) ABSTRACT

System and methods provide driver performance rating and driving coaching feedback and make incident and exceedance predictions. Driving event data including data spanning multiple separate driving trips is analyzed using a trend detection model to generate a trend detection result that is used to determine a driver performance rating. The trend detection model may be a functional regression model, a linear fit model and/or a polynomial fit model. Driver coaching signals representative of driving instructions are generated based results of the trend detection model applied to the driving event data. Driving incident predictions are made based on the results of the trend detection model applied to the driving event data to a predetermined threshold.

### TECHNICAL FIELD

The present disclosure relates to monitoring vehicle operation and automatically rating driver performance, providing driving coaching feedback, and making driving incident predictions, in order to improve performance and overall efficiency of drivers and vehicle fleets. Although the example embodiments will be described in connection with a commercial fleet application, it is to be appreciated that the embodiments are usable and may be applied to any moving vehicles including for example passenger fleets, construction vehicle, and the like.

### BACKGROUND

Systems for wirelessly collecting and transmitting operational data and video from a vehicle are known. One such system known as SafetyDirect® by Bendix Commercial Vehicle Systems LLC is a world-renowned leading example. With data delivered by the SafetyDirect® system, vehicle fleet operators and managers can assess driving records, develop targeted driver training that addresses the issues taking place on the road, and make other business decisions that affect improved performance and overall efficiency of drivers and vehicle fleets.

The SafetyDirect® system records events produced by signals when it is determined that those signals are above or below predetermined thresholds or within predetermined ranges that might be produced as a result of various vehicle operational events such as for example excessive braking events, unwanted lane departure events, insufficient headway events, etc. The event recordings may include sensor data, video image data, and/or other data that is representative of the vehicle operations of the event before, during and after the event (i.e., pre- and post-event (PPE) data) and the vehicle/driver signals/dynamics during the event (brake pressure, steering angle, speed, deceleration, location, etc.).

While the SafetyDirect® system has met with tremendous success, it is desirable to use event data and the event data generated by the SafetyDirect® system in particular to provide driver performance ratings in order to understand which drivers produce too many of such events and/or which drivers produce extreme events.

It is further desirable to use the driver performance ratings to rank the drivers among the complement of drivers in a fleet operation.

It is further desirable to use the event data to make driving incident predictions.

It is further desirable to use the event data to provide driving coaching feedback to selected drivers who may need driving instructional assistance based on their respective performance rating.

It is further desirable to use the driver performance ratings to utilize selected drivers among the complement of drivers in a fleet operation for particular driving tasks where the selected driver may be better able to perform the driving task than other fleet drivers in order to improve the overall performance and efficiency of vehicle fleets.

### SUMMARY

Described herein are systems, methods and computer readable mediums that are executable to use event data to provide driver performance assessments.

Described herein are systems, methods and computer readable mediums that are executable to use event data to provide driver performance ratings.

Further described herein are systems, methods and computer readable mediums that are executable to use the driver performance ratings to rank the drivers among a complement of drivers in a group such as for example drivers in a fleet operation.

Further described herein are systems, methods and computer readable mediums that are executable to use event data to make driving incident predictions.

Further described herein are systems, methods and computer readable mediums that are executable to use event data to provide driving coaching feedback to selected drivers who may need driving instructional assistance based on their respective performance rating.

Further described herein are systems, methods and computer readable mediums that are executable to use the driver performance ratings to utilize selected drivers among the complement of drivers in a fleet operation for particular driving tasks where the selected driver may be better able to perform the driving task than other fleet drivers.

Further described herein are systems, methods and computer readable mediums that are executable to develop event data from PPE data and to use the event data to provide driver performance assessments.

Further described herein are systems, methods and computer readable mediums that are executable to develop event data from PPE data and to use the event data to provide driver performance ratings.

Further described herein are systems, methods and computer readable mediums that are executable to develop event data from PPE data and to use the event data to make driving incident predictions.

Further described herein are systems, methods and computer readable mediums that are executable to develop event data from PPE data and to use the event data to provide driving coaching feedback to selected drivers who may need driving instructional assistance based on their respective performance rating or based on their driver performance assessment.

In accordance with an aspect, the disclosure herein relates to a system for assessing a driver's operation of a vehicle over a selected time period and automatically providing a driver performance rating of the driver's operation, wherein the system comprises a control circuit comprising a memory device, control logic stored in the memory device, and a processor operatively coupled with the memory device, wherein the processor is configured to execute the control logic to receive a set of event data representative of driving events comprising occurrences of operation of the vehicle during the selected time period being determined to be non-compliant operation, analyze the set of event data based on a trend detection model to generate a trend detection result, determine a driver performance rating of the driver's operation based on the trend detection result, and generate based on the determined driver performance rating a driver performance rating control signal for use in controlling one or more functional aspects of the vehicle.

In any of the implementations, the trend detection model may generate a trend detection result based on an analysis by driver over multiple trips for all events.

In any of the implementations, the trend detection model may generate a trend detection result based on an analysis by driver during single trips for all events.

In any of the implementations, the trend detection model may generate a trend detection result based on an analysis by both driver and event type over multiple trips.

In any of the implementations, the trend detection model may generate a trend detection result based on any combination of driver, vehicle, event, event type, single trip, and/or multiple trips.

In any of the implementations, the trend detection model may generate a trend detection result based on a combination of any of driver, vehicle, event, event type, single trip, and/or multiple trips.

In any of the implementations, the control circuit operates to deliver the driver performance rating control signal to an electronic control unit (ECU) of the vehicle to thereby control one or more functional aspects of the vehicle based on the determined driver performance rating.

In any of the implementations, the processor is configured to execute the control logic to receive the set of event data comprising event rate data representative of rates of occurrences of the driving events determined to be the non-compliant operation during each of a plurality of separate driving trips spanning the selected time period, analyze the event rate data based on the trend detection model to generate the trend detection result, and determine the driver performance rating of the driver's operation based on the trend detection result.

In any of the implementations, the processor is configured to execute the control logic to control the operation of the vehicle based on the determined driver performance rating.

In any of the implementations, the processor is configured to execute the control logic to receive the set of event data comprising event type data representative of types of the driving events during the selected time period being determined to be non-compliant operation, analyze the event type data based on the trend detection model to generate the trend detection result, and determine the driver performance rating of the driver's operation based on the trend detection result. In any of the implementations, the processor is configured to execute the control logic to control the operation of selected functional aspects of the vehicle based on the determined driver performance rating.

In any of the implementations, the processor is configured to execute the control logic to receive the set of event data comprising event type data representative of types of the driving events during the selected time period being determined to be non-compliant operation, analyze the event type data based on the trend detection model to generate the trend detection result, and determine the driver performance rating of the driver's operation based on the trend detection result. As noted, in any of the implementations, the processor is configured to execute the control logic to control the operation of selected functional aspects of the vehicle based on the determined driver performance rating.

In any of the implementations, the processor is configured to execute the control logic to analyze the set of event data based on a trend detection model comprising one or more of a functional regression model, a linear fit model and/or a polynomial fit model to generate the trend detection result, an determine the driver performance rating of the driver's operation based on the trend detection result. As noted, in any of the implementations, the processor is configured to execute the control logic to control the operation of selected functional aspects of the vehicle based on the determined driver performance rating.

In any of the implementations, the processor is configured to execute the control logic to analyze the set of event data using the one or more of the functional regression model, the linear fit model and/or the polynomial fit model applied to predetermined event types of the driving events comprising the occurrences of operation of the vehicle determined to be non-compliant operation.

In any of the implementations, the system further comprises driver coaching logic stored in the memory device, wherein the processor is configured to execute the driver coaching logic to generate a driver coaching signal representative of a driving instruction based on one or more of the determined driver performance rating and/or a degree of agreement between the one or more of the functional regression model, the linear fit model and/or the polynomial fit model and the set of event data, wherein the driving instruction of the driver coaching signal informs the driver recommended control of the operation of the vehicle based on the determined driver performance rating.

In any of the implementations, the processor is configured to execute the control logic to control the operation of selected functional aspects of the vehicle based on the determined driver performance rating by providing one or more driver coaching signals comprising any one or more of driving instructions, signals, warnings, and/or indications that instruct, aid and/or otherwise guide the driver of the vehicle recommended manners in which to operate the vehicle. In any of the implementations, the providing the one or more driver coaching signals comprising the any one or more of driving instructions, signals, warnings, and/or indications that instruct, aid and/or otherwise guide the driver of the vehicle can be said to directly or indirectly control selected operations of the vehicle based on the provided one or more driver coaching signals.

In any of the implementations, the system further comprises an annunciator operatively coupled with the processor, wherein the processor is configured to execute the driver coaching logic to annunciate the driving instruction to the driver via the annunciator. In any of the implementations, the driving instruction annunciated to the driver via the annunciator provides for control over selected functional aspects of the vehicle, wherein the driving instruction informs the driver of recommended manners in which to operate the vehicle.

In any of the implementations, the system further comprises incident prediction logic stored in the memory device, and incident threshold data stored in the memory device, wherein the processor is configured to execute the incident prediction logic to determine a driving incident prediction by determining an imminent intersection of a trajectory or event rate level resulting from fitting the trend detection model to the set of event data with a predetermined threshold setting represented by the incident threshold data stored in the memory device. In any of the implementations, the processor is configured to execute the incident prediction logic to determine a driving incident prediction by determining an imminent intersection of a trajectory or critical level resulting from fitting the trend detection model to the set of event data with a predetermined threshold setting represented by the incident threshold data stored in the memory device.

In accordance with an aspect, the disclosure herein relates to a method for assessing a driver's operation of a vehicle over a selected time period and automatically providing a driver performance rating of the driver's operation. The method includes receiving a set of event data by a control circuit comprising a memory device, control logic stored in the memory device, and a processor operatively coupled with the memory device, wherein the set of event data is representative of driving events comprising occurrences of operation of the vehicle during the selected time period being determined to be non-compliant operation. The method further includes analyzing by the processor executing control logic stored in the memory device the set of event data based on a trend detection model to generate a trend detection result. The method still further includes determining by the processor executing control logic stored in the memory device a driver performance rating of the driver's operation based on the trend detection result. The method further still includes generating by the processor executing control logic stored in the memory device based on the determined driver performance rating a driver performance rating control signal for use in controlling one or more functional aspects of the vehicle.

In any of the implementations, the method further includes delivering the driver performance rating control signal to an electronic control unit (ECU) of the vehicle to thereby control one or more functional aspects of the vehicle based on the determined driver performance rating.

In any of the implementations, the method further includes receiving the set of event data comprising event rate data representative of rates of occurrences of the driving events determined to be the non-compliant operation during each of a plurality of separate driving trips spanning the selected time period, analyzing by the processor executing control logic the event rate data based on the trend detection model to generate the trend detection result, and determining by the processor executing control logic the driver performance rating of the driver's operation based on the trend detection result.

In any of the implementations, the method further includes receiving the set of event data comprising event type data representative of types of the driving events during the selected time period being determined to be non-compliant operation, analyzing by the processor executing control logic the event type data based on the trend detection model to generate the trend detection result, and determining by the processor executing control logic the driver performance rating of the driver's operation based on the trend detection result.

In any of the implementations, the method further includes receiving the set of event data comprising event type data representative of types of the driving events during the selected time period being determined to be non-compliant operation, analyzing by the processor executing control logic the event type data based on the trend detection model to generate the trend detection result, and determining by the processor executing control logic the driver performance rating of the driver's operation based on the trend detection result.

In any of the implementations, the method further includes analyzing by the processor executing control logic the set of event data based on a trend detection model comprising one or more of a functional regression model, a linear fit model and/or a polynomial fit model to generate the trend detection result, and determining by the processor executing control logic the driver performance rating of the driver's operation based on the trend detection result.

In any of the implementations, the method further includes analyzing by the processor executing the control logic the set of event data using the one or more of the functional regression model, the linear fit model and/or the polynomial fit model applied to predetermined event types of the driving events comprising the occurrences of operation of the vehicle determined to be non-compliant operation.

In any of the implementations, the method further includes generating a driver coaching signal by the processor executing driver coaching logic stored in the memory device, wherein the driver coaching signal is representative of a driving instruction based on one or more of the determined driver performance rating and/or a degree of agreement between the one or more of the functional regression model, the linear fit model and/or the polynomial fit model and the set of event data, wherein the driving instruction of the driver coaching signal informs the driver recommended control of the operation of the vehicle based on the determined driver performance rating.

In any of the implementations, the method further includes executing the driver coaching logic to annunciate by an annunciator operatively coupled with the processor the driving instruction to the driver.

In any of the implementations, the method further includes determining by the processor executing incident prediction logic stored in the memory device a driving incident prediction by determining an imminent intersection of a trajectory or event rate threshold resulting from fitting the trend detection model to the set of event data with a predetermined threshold setting represented by the incident threshold data stored in the memory device. In any of the implementations, the processor determines an imminent intersection of a trajectory or critical level resulting from fitting the trend detection model to the set of event data with a predetermined threshold setting represented by the incident threshold data stored in the memory device.

The various examples described above can be combined with each other in further examples.

It is to be understood that the features mentioned above and those yet to be explained below may be used not only in the respective combinations indicated, but also in other combinations or in isolation without departing from the scope of the invention.

Other aspects, embodiments, features and advantages of the example embodiments will become apparent from the following description of the embodiments, taken together with the accompanying drawings, which illustrate, by way of example, the principles of the example embodiments.

### BRIEF DESCRIPTION OF THE DRAWINGS

In the accompanying drawings which are incorporated in and constitute a part of the specification, embodiments of the invention are illustrated, which, together with a general description of the implementations given above, and the detailed description given below, serve to exemplify the embodiments of this disclosure.

FIG. 1 illustrates an overview of a fleet system in accordance with an example embodiment.

FIG. 2A illustrates is a schematic block diagram of a driving assessment system according to an example embodiment.

FIG. 2B illustrates a simplified schematic block diagram of the driving assessment system in FIG. 2A.

FIG. 3 is a flow diagram illustrating a method of rating driver performance, providing driving coaching feedback, and making driving incident predictions in accordance with an embodiment.

FIG. 4 is a block diagram illustrating logic modules executable by a processor of the driving assessment system in accordance with an embodiment.

FIG. 5 is a graph illustrating driver assessment in accordance with an embodiment.

FIG. 6 is a graph illustrating driver assessment in accordance with an embodiment.

FIG. 7A is an example graphical user interface screen showing a fleet overview landing page view generated by the driving assessment system according to an example embodiment.

FIG. 7B is an example graphical user interface screen showing a drivers overview page view generated by the driving assessment system according to an example embodiment.

FIG. 7C is an example graphical user interface screen showing a selected driver's overview page view generated by the driving assessment system according to an example embodiment.

### DETAILED DESCRIPTION OF THE EXAMPLE EMBODIMENTS

In the following description of the present invention reference is made to the accompanying drawing Figures which form a part thereof, and in which are shown, by way of illustration, exemplary embodiments illustrating the principles of the disclosed systems rating driver performance, providing driving coaching feedback, and making driving incident predictions, and methods of rating driver performance, providing driving coaching feedback, and making driving incident predictions, and how the embodiments are practiced. Other embodiments can be utilized to practice the disclosed methods and systems rating driver performance, providing driving coaching feedback, and making driving incident predictions, and structural and functional changes can be made thereto without departing from the scope of the disclosure.

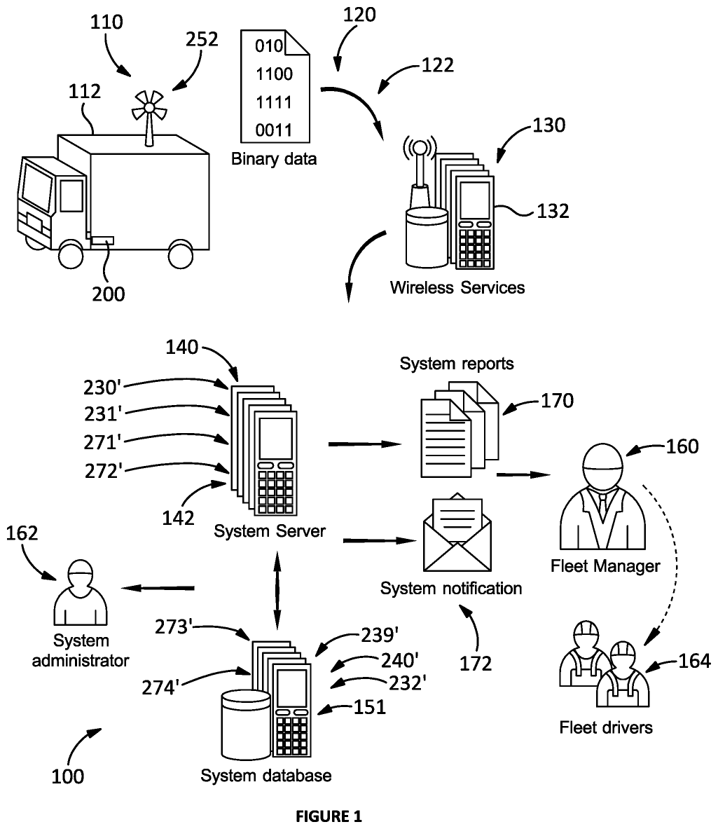

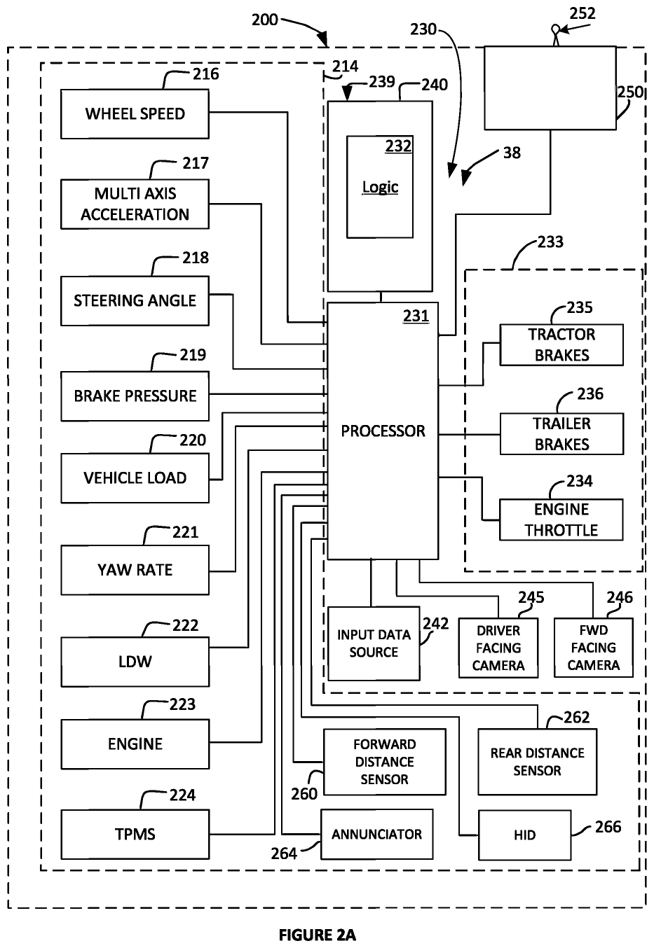

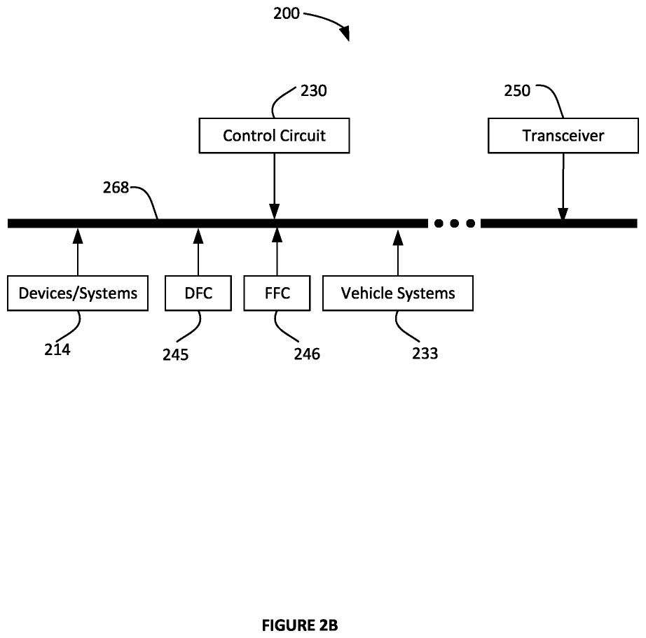

Referring now to the drawings, wherein the showings are for the purpose of illustrating the example embodiments only, and not for purposes of limiting the same, FIG. 1 illustrates an overview of a fleet system 100 configured to rate driver performance, provide driving coaching feedback, and make driving incident predictions in accordance with an example embodiment of the present disclosure. In this example embodiment, vehicles 110, such as trucks and cars, and particularly fleet vehicles 112 in accordance with an example implementation may be configured with a driving assessment system 200 (see FIG. 2A), which may comprise an in-vehicle computing system that generates actual data relating to driving and vehicle events that may be of interest to a fleet manager or other user. Such a system 200 may include for example a lane departure warning (LDW) system 222 (FIG. 2A) that may generate signals indicative of an actual lane departure, such as lane wandering or crossing. Additionally, secondary systems to be described in greater detail below with reference to FIG. 2A may be carried by the vehicles or installed in the vehicle systems, including one or more video cameras, radar, light detection and ranging (LIDAR), transmission, engine, tire pressure monitoring and braking systems, for example, that may generate additional safety event data and driver behavior data. Front facing cameras, radar and LIDAR-based system may also be used to provide data relating to driver behavior in the context of following distance, headway time, response to speed signs, and anticipation of needed slowing. In accordance with the example embodiments, the driving assessment system 200 may record events produced by signals when it is determined that those signals are above or below predetermined thresholds or within predetermined ranges that might be produced as a result of various vehicle operational events such as for example excessive braking events, unwanted lane departure events, insufficient headway events, etc. The event recordings may be saved as event data and may include sensor data, video image data, and/or other data that is representative of the vehicle operations of the event such as for example PPE data, and the vehicle/driver signals/dynamics during the event (brake pressure, steering angle, speed, deceleration, location, etc.). In accordance with the example embodiments, the driving assessment system 200 may receive event data from one or more other system(s) of the vehicle such as from a SafetyDirect® system or the like.

With continued reference to FIG. 1, event data 120 collected and/or otherwise generated at the vehicle 112 may be selectively sent via a communication link 122 to communication network servers 132 of one or more communication service providers 130. Communication service providers 130 may utilize the communication network servers 132 (only one shown for ease of illustration) that collect the event data 120 provided by the vehicles 112.

One or more servers 140 of the fleet system 100 may be configured to selectively download, receive, or otherwise retrieve data either directly from the vehicles 112 via the communication service providers 130 or from the communication network servers 132 which may be third party servers from one or more various telematics suppliers or cellular providers. Servers 140 may be configured to initiate processing of the event data in manners to be described in greater detail below.

A web application 142 executable on the one or more servers 140 of the fleet system 100 may include a dynamic graphical user interface for fleet managers 160 and/or for fleet or system administrators 162 to view all the information once it is processed. The fleet system 100 of the example embodiment may also include one or more databases 151 configured to selectively store all event information provided from the vehicles 112 in the fleet of vehicles 110 for one or more designated time intervals, including raw and post-processed trip data.

In accordance with the example embodiment, the fleet managers 160 and/or for fleet or system administrators 162 may be users who are provided with interfaces to configure and manage fleets, monitor platform performance, view alerts issued by the platform, and view driver and event data and subsequent processing logs and/or views. The fleet managers 160 and/or for fleet or system administrators 162 may view event information for their respective fleet for internal processing. These events may arrive via system reports 170 in the web application 142 executable on the one or more servers 140, or via email or via any one or more other notifications 172. Fleet managers 160 and/or for fleet or system administrators 162 may, depending on internal policies and processes or for other reasons, also interface with individual fleet drivers 164 regarding performance goals, corrections, reports, or coaching. The fleet managers 160 and/or for fleet or system administrators 162 may also, depending on internal policies and processes or for other reasons, also interface with individual fleet drivers 164 regarding automatically rating driver performance, providing driving coaching feedback, and making driving incident predictions, in order to improve performance and overall efficiency of the fleet drivers 164 and fleet vehicles 110.

Referring now to FIG. 2A, depicted is a schematic block diagram that illustrates details of a driving assessment system 200 mentioned above, and which is configured to be used in accordance with an embodiment of the present subject matter. As further detailed below, the driving assessment system 200 may be an in-vehicle driving assessment system. In the example implementation, the driving assessment system 200 may be may be adapted to detect a variety of operational parameters and conditions of the vehicle 112 and also adapted to detect a variety of operational parameters and conditions of the driver's interaction with the vehicle and, based thereon, to determine if one or more driving event(s) and/or vehicle event(s) has/have occurred (e.g., if one or more operational parameter/condition thresholds has been exceeded). The driving assessment system 200 may be adapted to automatically determine driver performance assessments, rate driver performance, provide driving coaching feedback, and make driving incident predictions, in order to improve performance and overall efficiency of drivers and fleet vehicles 110. Data related to detected events (i.e., event data) may then be stored locally at a driving assessment system 200 disposed in the vehicle 112 and/or transmitted to a remote location/server 140, as described in more detail below. In addition, the data related to the detected events (i.e., event data) that are stored locally (in-vehicle) may also be processed locally (in-vehicle) for automatically providing driver performance ratings, making driving incident predictions, and/or providing driving coaching feedback. In further addition, the data that is transmitted to the remote location/system server 140 may be processed at the remote location/system server 140 for automatically providing driver performance ratings, making driving incident predictions, and/or providing driving coaching feedback for use at the remote location/system server 140 and/or for transmission back to the driver in the one or more fleet vehicles 110 for use by the drivers in particular vehicles 112.

The driving assessment system 200 of FIG. 2A may include one or more devices or systems 214 for providing input data indicative of one or more operating parameters or one or more conditions of a vehicle 112. Alternatively, the driving assessment system 200 may include a signal interface for receiving signals from the one or more devices or systems 214, which may be configured separately from the system 200. The one or more devices or systems 214 may be one or more sensors such as, but not limited to, one or more wheel speed sensors 216, one or more acceleration sensors/accelerometers, such as multi-axis acceleration sensors 217, a steering angle sensor 218, a brake pressure sensor 219, one or more vehicle load sensors 220, a yaw rate sensor 221, a lane departure warning (LDW) sensor and/or system 222, one or more engine speed or engine condition sensors 223, and a tire pressure monitoring system (TPMS) 224. The driving assessment system 200 may also utilize additional devices or sensors in the exemplary embodiment including, for example, a forward distance sensor 260 and a rear distance sensor 262. The forward and/or rear distance sensors 260, 262 may be any type of sensors including for example radar sensors, LIDAR sensors, etc. Other sensors and/or actuators or power generation devices or combinations thereof may be used or otherwise provided as well, and one or more devices or sensors may be combined into a single unit as may be necessary and/or desired.

The driving assessment system 200 may also include an annunciator device 264 that may include one or more of instrument panel lights, speakers, buzzers, chimes, haptic actuators, etc. that may be usable by the driving assessment system 200 to provide headway time/safe following distance warnings, lane departure warnings, and warnings relating to braking and or obstacle avoidance events. The annunciator device 264 of the driving assessment system 200 may be usable to provide one or more driver performance ratings, provide driving coaching feedback, and make driving incident predictions, in order to improve performance and overall efficiency of drivers and vehicle fleets. The driving assessment system 200 further includes a human interface device (HID) 266 which can be any kind of device that is configured to provide an interface between the driver and the driving assessment system 200. The human interface device 266 may include, in an example, a computing or any other device capable of facilitating exchanges of video, audio and text outputs and/or inputs between the driver and the driving assessment system 200 (e.g., phone, pad, PC). As further described herein, driver performance rating information, driving coaching feedback, and incident prediction information may be provided directly to the driver via the human interface device 266 such as for example via the driver's computing device or the like. Alternatively, the driver performance rating information, driving coaching feedback, and incident prediction information may be provided to the driver and/or to the fleet managers 160 and/or administrators 162 (FIG. 1) via a similar system provided by the web application 142 executable on the one or more servers 140 of the fleet system 100 to view all the information once it is processed.

The driving assessment system 200 may also include a logic applying arrangement such as a control circuit 230 that is in communication with the one or more devices or systems 214. The control circuit 230 of the example embodiment includes a controller device or processor 231, a memory device 240, and control logic 232 stored in the memory device 240. The processor 231 may include one or more inputs for receiving input data from the devices or systems 214. The processor 231 may be adapted to process the input data and compare the raw or processed input data to one or more stored threshold values or desired averages or time history shapes, or to process the input data and compare the raw or processed input data to one or more circumstance-dependent desired values and/or value evolutions. The role of the processor 231 may be to process input and outputs regarding safety, warning, or indication systems of the vehicle 112 and may be distinct from other onboard processors of the vehicle 112 that perform tasks such as controlling the ignition timing, obtaining measurements from a mass airflow sensor (MAF), pulsing fuel injectors, and the like. Processor 231 may communicate with other one or more processors and/or systems of the vehicle 112 via a vehicle data bus, such as for example a Controller Area Network (CAN bus) of the vehicle, for example.

The processor 231 may also include one or more outputs for delivering one or more control signals to one or more vehicle systems 233 and/or to one or more of the devices or systems 214 based on one or more results of the determined driver performance rating, the driving coaching feedback, and/or the driving incident predictions. The control signals may instruct the one or more systems 233 and/or the devices or systems 214 to provide one or more types of driver assistance warnings (e.g., warnings relating to braking and or obstacle avoidance events) and/or to intervene in the operation of the vehicle 112 to initiate corrective action. For example, the processor 231 may generate and send a control signal to an engine electronic control unit or to an actuating device to reduce the engine throttle 234 and slow the vehicle 112 down. Further, the processor 231 may send a control signal to one or more vehicle brake systems 235, 236 to selectively engage the brakes (e.g., a differential braking operation). Further, the processor 231 may send a control signal to one or more vehicle LDW systems 222 for adjusting a parameter of the LDW system 222 based on the determined driver performance rating. An adjustment of distance maintenance systems may be initiated. The processor 231 may send a control signal to any of the one or more vehicle systems 214 for adjusting any one or more parameters thereof based on the determined driver performance rating, driver ranking and/or coaching determination. A variety of corrective actions and/or other actions providing driver assistance are possible, and multiple corrective and/or assistive actions may be initiated and executed at the same time. In accordance with an example embodiment, the driving assessment system 200 generates a driver performance rating control signal based on the determined driver performance rating. The driver performance rating control signal may be used by the vehicle 112 for use in controlling one or more functional aspects thereof such as for example for use in controlling any one or more of the vehicle systems 233 and/or the devices or systems 214 based on one or more results of the determined driver performance rating, the driving coaching feedback, and/or the driving incident predictions.

The driving assessment system 200 in general includes a memory portion 239 for storing and accessing system and other information, such as the system control logic 232. The memory portion 239 may be physically independent of the processor 231 as illustrated in FIG. 2A as a separate memory device 240 or may equivalently be integrated within the processor 231. Further, the sensors 214 and processor 231 of the driving assessment system 200 may be part of a pre-existing system already installed in the vehicle 112 or may use components of any one or more pre-existing system(s) already installed in the vehicle 112. The devices, sensors, or systems 214, 230, 233 may be part of a preexisting system or use components of a preexisting system. For example, the Bendix® ABS-6™ Advanced Antilock Brake Controller with ESP® Stability System available from Bendix Commercial Vehicle Systems LLC may be installed on the vehicle. The driving assessment system 200 may be integrated with the Bendix ESP® system, which may utilize some or all of the devices, sensors, or systems described in FIG. 2.

Likewise, and in accordance with an embodiment, the memory device 240 and control circuit 230 of the driving assessment system 200 may be shared with other vehicle systems. For instance, the logic component of the Bendix ESP® system (described above) resides on the vehicle's antilock brake system electronic control unit (“ECU”). Accordingly, the antilock brake system ECU may be used for the control circuit 230 of the driving assessment system 200. In other embodiments, the engine ECU of the vehicle may be used as the control circuit 230 of the driving assessment system 200. In still other embodiments, the control circuit 230 of the driving assessment system 200 may share a control circuit and/or memory/storage with any one or more pre-existing system(s) already installed in the vehicle 112 or may use components of any one or more pre-existing system(s) already installed in the vehicle 112 including for example any one or more of the Bendix® ABS-6™ Advanced Antilock Brake Controller, the LDW system 222, the annunciator 264, and/or the HID 266. In still further embodiments, the memory device 240 and control circuit 230 of the driving assessment system 200 may be provided in the form of a dedicated to the data collection module. In a further embodiment, the control circuit 230 of the driving assessment system 200 system may be executed or otherwise implemented on a processor such as for example on an i.MX 6 processor.

The driving assessment system 200 may also include a source of input data 242 indicative of a configuration/condition of a vehicle 112. The processor 231 may sense or estimate the configuration/condition of the vehicle 112 based on the input data, and may select a control tuning mode or sensitivity based on a configuration and/or condition of the vehicle. The processor 231 may compare the operational data received from the sensors or systems 214 to the information provided by the tuning.

It is to be appreciated that the processor 231 may equivalently be disposed at the system server 140 in accordance with an example embodiment. A control circuit 230′ of an example embodiment may be disposed at the system server 140 and may include a controller device or processor 231′, a memory device 240′, and control logic 232′ stored in the memory device 240′. The processor 231′ at the system server 140 may include one or more inputs for remotely receiving input data from the devices or systems 214 of the vehicle. The processor 231′ disposed at the system server 140 may be adapted to process the input data and compare the raw or processed input data to one or more stored threshold values or desired averages or time history shapes, or to process the input data and compare the raw or processed input data to one or more circumstance-dependent desired values and/or value evolutions. The role of the processor 231′ may be to process input and outputs regarding safety, warning, or indication systems of the vehicle 112 and may be distinct from other onboard processors of the vehicle 112 that perform tasks such as controlling the ignition timing, obtaining measurements from a mass airflow sensor (MAF), pulsing fuel injectors, and the like. Processor 231′ disposed at the system server 140 may communicate with other one or more processors and/or systems of the vehicle 112 via one or more transmitter/receivers (transceiver) modules 250, such as a radio frequency (RF) transmitter, including one or more antennas 252 for wireless communication of the automated control requests for example.

In addition, the driving assessment system 200 may be operatively coupled with one or more imaging devices such as one or more driver-facing imaging devices for example, shown in the example embodiment for simplicity and ease of illustration as a single driver facing camera 245 that may be trained on the driver and/or trained on the interior of the cab of the vehicle 112. However, it should be appreciated that one or more physical video cameras may be disposed on the vehicle 112, such as a video camera on each corner of the vehicle 112, one or more cameras mounted remotely and in operative communication with the driving assessment system 200, such as a forward-facing camera 246 to record images of the roadway ahead of the vehicle 112. In the example embodiments, driver data may be collected directly using the driver facing camera 245 in accordance with a detected driver head position, hand position, or the like, within the vehicle being operated by the driver. In addition, driver identity may be determined based on facial recognition technology and/or body/posture template matching.

The driving assessment system 200 may also include a transmitter/receiver (transceiver) module 250, such as a radio frequency (RF) transmitter, including one or more antennas 252 for wireless communication of the automated control requests, GPS data, one or more various vehicle configuration and/or condition data, or the like between the vehicles and one or more destinations such as to one or more services of one or more communication service providers 130 of one or more communication network servers 132 having one or more corresponding receiver and antenna. In an example, the transceiver may communicate cellularly using its antenna 252 over a cellular telephone network with a cloud-based computing system. The cloud computing system may be implemented, for example, by one or more servers 140 (FIG. 1), and/or the communication network servers 132. The transmitter/receiver (transceiver) module 250 may include various functional parts of sub portions operatively coupled with a platoon control unit including for example a communication receiver portion, a global position sensor (GPS) receiver portion, and a communication transmitter. For communication of specific information and/or data, the communication receiver and transmitter portions may include one or more functional and/or operational communication interface portions as well.

The processor 231 may be operated to execute portions of the system control logic 232 to combine selected ones of the collected signals from the sensor systems described above into processed data representative of higher-level vehicle condition data, such as data from the multi-axis acceleration sensors 217, that may be combined with the data from the steering angle sensor 218 to determine excessive curve speed event data as an example. Other hybrid event data relatable to the vehicle 112 and driver of the vehicle 112 and obtainable from combining one or more selected raw data items from the sensors includes, for example and without limitation, excessive braking event data, excessive curve speed event data, lane departure warning event data, excessive lane departure event data, lane change without turn signal event data, loss of video tracking (LOVT) event data, LDW system disabled event data, distance alert event data, forward collision warning event data, haptic warning event data, collision mitigation braking event data, ATC event data, ESP event data, RSP event data, ABS event data, TPMS event data, engine system event data, average following distance event data, average fuel consumption event data, average ACC usage event data, excessive lane changing, improper environmental awareness scanning, and late speed adaptation (such as that given by signage or exiting).

The driving assessment system 200 of FIG. 2A may be suitable for executing embodiments of one or more software systems or modules that perform driver performance assessment, driver performance rating, driving coaching feedback, and incident prediction methods according to the subject application. The example driving assessment system 200 may include a bus or other communication mechanism for communicating information, and a processor 231 coupled with the bus for processing information. The computer system includes a memory device 240, such as random-access memory (RAM) or other dynamic storage device for storing instructions to be executed by the processor 231, and read only memory (ROM) or other static storage device for storing other static information and instructions for the processor 231. Other storage devices may also suitably be provided for storing information and instructions as necessary or desired.

Instructions may be read into the memory device 240 from another computer-readable medium, such as another storage device via the transceiver 250. Execution of the sequences of instructions contained in the memory device 240 by the processor 231 may cause the driving assessment system 200 to perform one or more of the process steps described herein. In an alternative implementation, hard-wired circuitry may be used in place of or in combination with software instructions to implement the present subject matter. Thus, implementations of the example embodiments are not limited to any specific combination of hardware circuitry and software.

FIG. 2B illustrates a simplified schematic block diagram of the driving assessment system 200 of FIG. 2A. Referring now to FIG. 2B, only certain components of the event detection and reporting system 200 of FIG. 2A are depicted. As shown, various components of the system 200 are shown as being in communication with the control circuit 230 by being connected to a vehicle bus 268, which can be a private bus dedicated to the system 200 or a general vehicle bus such as for example a CAN bus, and the like. As shown, in addition to DFC 245, FFC 246, the one or more devices or systems 214, the one or more vehicle systems 233, and the transceiver module 250 are operatively coupled with the control circuit 230 via the vehicle bus 268.

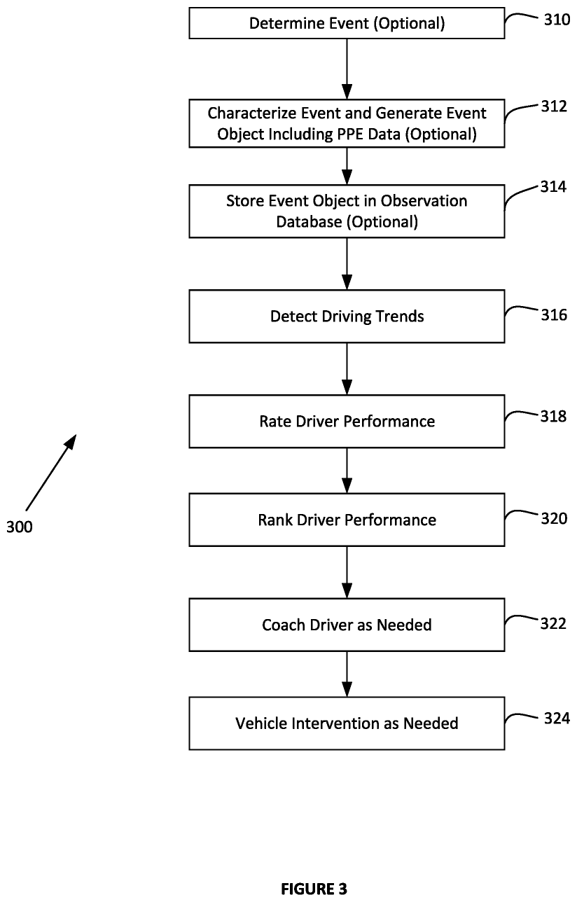

FIG. 3 is a flow diagram illustrating a method 300 of rating driver performance, providing the driver performance rating, providing driving coaching feedback, and making incident predictions in accordance with an embodiment. In the example embodiment, the processor 231 of the control circuit 230 executes control logic 232 stored in a memory portion 239 of the control circuit 230 to perform the method 300 the details of which will be explained in greater detail below. In a further example embodiment, a processor 231′ of a control circuit 230′ disposed at the system server 140 executes control logic 232′ stored in a memory portion 239′ disposed at the system database 151 to perform the method 300 the details of which will be explained in greater detail below.

In general, however, a driving event is determined at 310, wherein the driving event may relate to any number of driving-related occurrences that might take place over time and that might have importance relative to developing driver performance ratings, determining driver rankings for fleet operation applications, determining whether driving coaching is needed or necessary, to perform vehicle intervention operations based on the events and/or driver ratings, etc.

The events are characterized at 312 and they are associated with PPE data to generate event objects. Events may be characterized by the distances, velocities, forces, durations, irregularities, variations, etc. involved. By way of an example, an event with large irregular lateral forces both to the right and left may be considered more severe than one with smaller, smoother forces to one side only.

The event objects are stored in an observation database at 314. The observation database at 314 may be disposed at the memory device 240, for example. In a further example embodiment, the observation database at 314 may be disposed in the system database 151, for example.

Driving trends are detected by the processor 231, 231′ executing at 316 the control logic 232, 232′.

Drivers' performance ratings are determined by the processor 231, 231′ executing at 318 the control logic 232, 232′.

The performance ratings of two or more drivers such as for example multiple members of a fleet operation are ranked by the processor 231, 231′ executing at 320 the control logic 232, 232′.

The one or more drivers having driving trends detected at 316 may be coached as necessary and/or desired by the processor 231, 231′ executing at 322 the control logic 232, 232′.

The driving assessment system 200 may selectively intervene in selected operations of the vehicle at 324 based on driving events, driving trends, driver rankings, and combinations thereof.

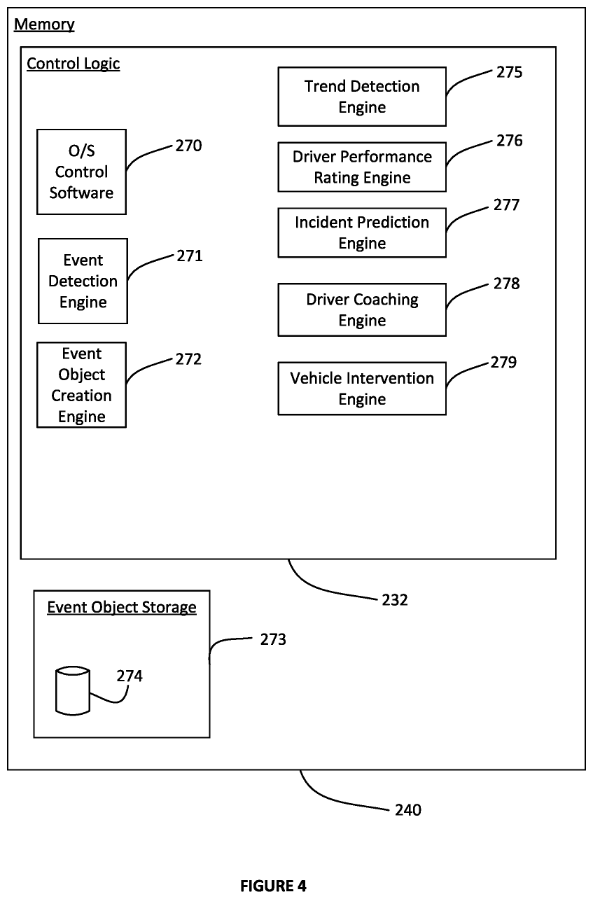

FIG. 4 is a block diagram illustrating logic modules that are executable by the processor 231 of the control circuit 230 of the driving assessment system 200 in accordance with an embodiment. Turning now to that Figure and in accordance with an example embodiment, the control logic 232 may comprise several logic modules that may be executed by the processor 231 of the control circuit 230 separately and/or in groups simultaneously as may be necessary or desired to perform different various operations related to providing the driver performance rating and driving coaching feedback, and also relating to making the driving incident predictions. To that end, the memory device 240 stores O/S control software 270 that may include firmware or an operating system (OS). By way of example and depending on implementation of the driving assessment system 200, the O/S control software 270 is executable by the processor 231 to provide an operating system of the driving assessment system 200 that may correspond to Linux, Unix, Android, iOS, etc.

The memory device 240 further stores an event detection engine 271 that is executable by the processor 231 to determine 310 (FIG. 3) whether an event has occurred. Input data is received from devices, systems or sensors of the driving assessment system 200. The input data is analyzed with reference to a threshold value and/or value evolution. It is determined that an event has occurred when the value of the input data is determined to be a predefined value relative to the threshold value or in exceedance of the value evolution.

Some events may be determined to have occurred when the input data is determined to be a predefined value relative to the threshold value for a specified period of time. Other events may be determined to have occurred when the input data from multiple devices, sensors, or systems of the data collection module are determined to be a predefined value and/or duration relative to respective threshold values. An example of an event determining rule may be the vehicle average deceleration exceeding 0.25 g for at least 1 second, a significant, protacted, slowing.

Examples of predefined driving events that may be determined from data received by the driving assessment system 200 include persistent, over a threshold, acceleration—either longitudinally or laterally (e.g., based on data received from multi-access acceleration sensor 217); a high steering rate over a period of time when driving over a certain speed (e.g., based on data received from wheel speed sensor 216 and/or steering angle sensor 218); persistent insufficient headway time to a vehicle ahead (e.g., based on data received from forward distance sensor 260); large amplitude, un-signaled, lane departure (e.g., based on data received from lane departure warning system 222), etc. Further events are available in the current Bendix SafetyDirect® system, which captures 20 seconds of imagery around such events, both prior to and following the event (i.e., in a black box fashion).

It is to be appreciated that the event detection engine may be disposed on the system server 140 and executable by the web application 142 to determine 310 (FIG. 3) whether an event has occurred. Input data is received from devices, systems or sensors of the driving assessment system 200 via the event data 120 may be selectively sent via communication links 122 to the communication network servers 132 of one or more communication service providers 130. Communication service providers 130 may utilize the communication network servers 132 (only one shown for ease of illustration) that collect the event data 120 provided by the vehicles 112. The input data is analyzed with reference to a threshold value and/or value evolution. It is determined that an event has occurred when the value of the input data is determined to be a predefined value relative to the threshold value or in exceedance of the value evolution.

Additional examples of driving events that may be detected or reported by, or collected from, a data collection module or other devices or sensors include, but are not limited to:
the presence of the vehicle in a predefined area, where the area is defined on a map including the route of the driving excursion, and where a GPS signal is used to determine when the vehicle enters and/or leaves the predefined location—city, state, zip code, terrain, etc., may be associated with the predefined areas;
speed, or speed range;
gear or gear range;
brake pressure, braking type, or brake usage;
engine rpm (e.g., either throttled or de-throttled);
fuel flow (e.g., unusually high or low, for a given road section, for a given time of day, for a given driver, for a given vehicle);
traffic proximity (e.g., a following-too-close event);
by road type (e.g., highway, primary, rough, smooth).
Lane Departure Warning—Crossing lane marking without using turn signal, and going back into original lane;
Excessive Lane Departure—Crossing lane marking without turn signal and continuing past a second limit, set at a particular distance past the inside of the lane marking;
Lane Change w/o Turn Signal—Crossing a lane mark without using turn signal, and continuing to adjacent lane;
Loss of Video Tracking—The unit has not been able to track for a period of ten minutes. This may be caused by, for example, tampering or the lens being covered;
LDW System Disabled-System Disabled by driver;
Distance Alert—An audible and visual warning, alerting the driver that the distance between the vehicle and a forward vehicle is some number of seconds or less.
Forward Collision Warning—An urgent audible and visual warning of an impending collision with another vehicle or object;
Haptic Warning—This may be in the form of a brake pulse applied to the vehicle to warn of an impending collision if the driver has not reacted to the Distance Alert nor the Forward Collision Warning;
Collision Mitigation Braking—Automated de-throttling of the engine, and/or application of the engine and foundation brakes when an collision is imminent
ATC—An event where engine braking and/or foundation braking occurs to prevent loss of traction at the wheels of the vehicle;
ESC—An event where engine braking and/or foundation braking occurs to prevent vehicle directional instability in order to keep the vehicle traveling on its intended path;
RSC—An event where engine braking and/or foundation braking occurs to stabilize the vehicle during a possible roll-over situation;
ABS—A driver initiated brake event when the ABS system is activated;
Excessive Braking—Braking with a longitudinal deceleration in excess of 0.4 g, while at speeds greater than 20 mph;
Excessive Curve Speed High speed going through curve. Limit for event log, for example, is a lateral acceleration of 0.4 g;
Tire Pressure—Monitoring for low tire pressure in any wheel and monitoring for instantaneous tire pressure in all tires of vehicle equipped with pressure sensors;
Engine Data—various engine parameters and metrics such as temperature, low oil pressure, high revs detection, and the like.

Statistical data generated by the event detection engine 271 of the example embodiment may include:
Average following distance—An average following distance measured in seconds, for the time a vehicle is followed and tracked by radar (or vision FCW);
Average ACC use—Percentage of driving time driven with Autonomous Cruise Control (ACC) system (if available) activated.

Data captured for a particular event may include:
Event Type;
Day/Night;
System Status—For example, whether it is tracking, not tracking, low speed, fault detected, etc.;
Speed of event;
Warning active;
Warning Left;
Warning Right;
Lane Change Left;
Lane change Right;
X acceleration—Longitudinal acceleration/braking;
Y acceleration—Lateral acceleration;
Odometer;
DTCs present-Diagnostic Trouble Codes of LDW, ABS systems;
Time of day;
Date;
Latitude—From GPS (if available);
Longitude—From GPS (if available);
   Driver ID.
Tire pressure lower than predetermined threshold.

Data for a particular severe event is collected if a severe event threshold is exceeded, for example for 10 seconds before and after the event. Data is saved in increments of time, for example every 250 ms. Severe event data may include:
Vehicle speed (mph);
Tractor Yaw (1/mile)—Curvature, amount of turning;
Turning Force (g)—this is technically y-acceleration;
Braking force (g)—his is technically x-acceleration;
Speed of forward vehicle (mph);
Distance to forward vehicle (ft);
Forward Collision Warning;
Target Detected;
ACC Mode;
Accelerator pedal (%);
Engine speed (rpm);
Brake pedal (%);
Collision Mitigation Braking—0.35 g brake request;
Haptic Warning—0.25 g brake pulsation;
ACC speed setting (mph);
Following Distance Alert using data collected from ACC system;
ABS Active;
ATC active (engine/brake)—Automatic Traction Control;
ESC active (engine/brake)—Electronic Stability Control;
RSC active (engine/brake)—Roll Stability Control;
ACC Shutdown message.

Another of the SafetyDirect® system fleet management and reporting system functionalities embedded in (embedded functionality) the driving assessment system 200 of the example embodiment is a video recording system and module that is capable of capturing a video feed using the LDW camera 245 (FIG. 2). When video recording is enabled, the driving assessment system 200 of the example embodiment continuously records a stream of images to a suitable memory buffer. The stream of images may be JPEG images for example, and the JPEG images may be streamed to dual alternating buffers for example. Once a triggering event is determined or otherwise recorded, a save process is initiated and video for that event is stored to non-volatile memory. The length of the video recordings is selectable within parameters between, for example, 0-30 seconds before and 0-30 seconds after an event. Video frame rate and resolution are also selectable and therefore customizable by the user.

Saving video may be triggered by any severe event and a parameter is available for the user to select which events and/or event types should trigger video to be saved. Once video is recorded, users may manually and/or automatically download video using a software tool. The driving assessment system 200 of the example embodiment also provides a method of transferring or transmitting the video files or images through different communications channels such as for example by using the transceiver module 250. Video data transmission may occur using small packets of data, so that video files may be rebuilt after reception for display. It is also contemplated that the MPEG format or any other formats may also be used as necessary or desired for video images for lossless compression.

As described above, the event detection engine 271 is executed by the one or more processors 231, 231′ to, in general, determine occurrences of events and to characterize the events into one or more event types. In order to preserve or otherwise memorialize this information in a useful way, an event object creation engine 272 is provided in accordance with the example embodiment wherein the object creation engine 272 is executed by the processor 231 to associate each event with relevant PPE data as event objects, and to store the event objects, once constructed or otherwise formed or assembled as logical objects, in an event object storage area 273 of the memory device 240. In an example embodiment, the event object storage area 273′ may be disposed at the system database 151, for example. Overall, therefore, the object creation engine 272 in general arranges the PPE data associated with the events according to a predefined structure. In the example embodiment, the event objects generated by the object creation engine 272 are stored in an observation database 274 so that the event objects may be easily and efficiently retrieved by one or more of the several modules of the control logic 232. Preferably in accordance with an example embodiment, each event object includes event characterization data that is representative of an event type assigned to it by the event detection engine 271. In addition, each event object includes a timestamp tag, a geolocation tag, a driver identification tag, and a trip identification tag.

In accordance with an example embodiment, the driving assessment system 200 of the example embodiment also provides a method of transferring or transmitting the event objects, once constructed or otherwise formed or assembled as logical objects by the event object creation engine 272, through different communications channels such as for example by using the transceiver module 250. In the example embodiment, the event objects may be selectively sent via communication links 122 to the communication network servers 132 of one or more communication service providers 130 as event data 120. Communication service providers 130 may utilize the communication network servers 132 (only one shown for ease of illustration) that collect the event data 120 provided by the vehicles 112. One or more servers 140 of the fleet system 100 may be configured to selectively download, receive, or otherwise retrieve the event data either directly from the vehicles 112 via the communication service providers 130 or from the communication network servers 132 which may be third party servers from one or more various telematics suppliers or cellular providers. Servers 140 may be configured to initiate processing of the event data. The servers 140 may be configured with an object creation engine 272′ to arrange the PPE data associated with the events according to a predefined structure. In the example embodiment, the event objects generated by the object creation engine 272′ executing at the servers 140 are stored in an observation database 274′ in the system database 151 so that the event objects may be easily and efficiently retrieved by one or more of the several modules of control logic executing on the web application 142 of the system servers 140. Preferably in accordance with an example embodiment, each event object includes event characterization data that is representative of an event type assigned to it by the event detection engine 271 executing on the web application 142 of the system servers 140. In addition, each event object received includes a timestamp tag, a geolocation tag, and a trip identification tag. A driver identification tag may be associated with one or more of the timestamp tag, the geolocation tag, and/or the trip identification tag by the event detection engine 271′ executing on the system sever 140. In this regard, the driver identification tag may be associated with one or more of the timestamp tag, the geolocation tag, and/or the trip identification tag by the event detection engine 271′ “after the fact” as that information may be delivered to the system server 140 via a separate communication channel other than via the communication link 122 and communication network servers 132 of the one or more communication service providers 130, such as via a backhaul or other channel to the backend system server 140.

In accordance with the example embodiment, the control logic 232 is executable by the processor 231 to receive the event objects by retrieving them from the observation database 274, to process the event objects, and to determine or otherwise assess a driver's performance rating based on a result of the processing. In addition, the control logic 232 may control one or more functional aspects of the vehicle based on the determined driver performance rating. In accordance with a further example embodiment, the control logic 232 is executable by the processor 231 to receive the event objects from the system server 140 (FIG. 1) via the transceiver 250 (FIG. 2), to process the event objects, and to determine or otherwise assess a driver's performance rating based on a result of the processing. In addition, the control logic 232 may control one or more functional aspects of the vehicle based on the determined driver performance rating. In accordance with a still further example embodiment, the control logic 232 is executable on the system server 140 by a processor 231 on the server to receive the event objects from the system database 151 (FIG. 1), to process the event objects locally at the system server 140, and to determine or otherwise assess a driver's performance rating based on a result of the processing. In addition, the control logic 232 may control one or more functional aspects of the vehicle based on the determined driver performance rating.

The adjusting the functional aspect of the vehicle based on the determined driver performance rating may comprise, for example, one or more of adjusting a content of a warning signal generated by the vehicle for warning the driver of potential danger relating to the vehicle operation, adjusting a format of the warning signal, and/or adjusting a style of the warning signal. In this regard, the adjusting the functional aspect of the vehicle based on the determined driver attention may comprise, for example, one or more of adjusting a content of an audible and/or visual warning signal generated by the audible and/or visual warning devices 264, 266 of the vehicle for warning the driver of potential danger, adjusting a format of the audible and/or visual warning signal(s), and/or adjusting a style of the audible and/or visual warning signal(s).

In further addition, the adjusting the functional aspect of the vehicle based on the determined driver performance rating may comprise, for example, one or more of making one or more changes to a warning setting, adding a new or additional sound to a warning, adjusting the timbre of a warning, add a new or additional light to a warning, add an audible human intelligible instruction to a warning, add a new warning, adding sound to an existing light-only warning, add light to an existing sound-only warning, making a change to a nature of a warning setting, increasing a volume of an existing sound warning, adding flash/strobe to an existing light warning, increasing a flash frequency of an existing flashing light warning, making changes to a brake system setting, or the like.

In still further addition, the adjusting the functional aspect of the vehicle based on the determined driver performance rating may comprise, for example, one or more of making one or more changes to one or more driver assistance systems of the vehicle such as for example making changes to parameters of one or more of an intelligent collision avoidance system, lane keeping aids, run-off road mitigation systems, cross traffic alert with or without auto brake systems, blind spot information systems, and surround view camera systems. The intelligent collision avoidance systems can detect and help the driver avoid a collision with other vehicles, pedestrians, cyclists, etc. The lane keeping aids may gently steer the vehicle car back into the lane if the vehicle is about to cross a lane marking without using the appropriate turn signal indicator and, if this steering intervention is not enough or if the driver keeps steering across the lane markings, the driver may be alerted with vibrations in the steering wheel. The run-off road mitigation driver assistance system helps prevent the driver and vehicle from accidentally leaving the road, wherein if the vehicle strays across the outer lane marking, the run-off road mitigation assistance system will help the driver steer the vehicle back onto the road and, further, if needed, the system may also activate the brakes as may be necessary to help keep the vehicle on the road. The cross-traffic alert assists the driver with an indication when reversing out of a parking space of approaching vehicles, and the system may also include auto brake wherein the vehicle brakes may be applied when an imminent collision is detected. The blind spot information system may provide an alert to the driver when a vehicle enters the driver's blind spot or approaches rapidly in a lane on either side of the vehicle, wherein the blind spot information system may alert the driver via a light in the left or right door side-view mirror. The surround view camera driver assist system includes cameras of the roadway imaging system 246 that provide a 360° bird's eye parking view so the driver can enter or exit any confined space including backing-up operations with confidence.

In accordance with an embodiment, the driving assessment system 200 includes a control circuit 230 comprising a memory device 240, control logic 232 stored in the memory device, and a processor 231 operatively coupled with the memory device. The processor is configured to execute the control logic to receive a set of event data representative of driving events comprising occurrences of operation of the vehicle during a protracted time period being determined to be non-compliant operation, analyze the set of event data based on a trend detection model to generate a trend detection result, determine a driver performance rating of the driver's operation based on the trend detection result, and control one or more functional aspects of the vehicle based on the determined driver performance rating. In accordance with any of the embodiments herein, a protracted time period is any selected time period. In this way, the time periods for any of the driver performance rating, the driving coaching feedback, and the making the driving incident predictions may be based on event data that occurred during any selected and selectable time period. The protracted time period may include a single separate driving trip, a portion of a single separate driving trip, several separate driving trips, or the like as desired, and may cover several hours, days, weeks, or months, etc. as desired.

In accordance with an embodiment, the set of event data may comprise event rate data representative of rates of occurrences of the driving events determined to be the non-compliant operation during each of a plurality of separate driving trips spanning the protracted time period. In accordance with an embodiment, the set of event data may also comprise the summed severities of the events over the protracted time period, that is, one may have the same number of events per time but of increasing severity. For example, one may have a constant number of lane departures per hour but these are tending toward larger amplitudes, i.e. are more excessive lane departures.

In accordance with an embodiment, the set of event data may comprise event type data representative of types of the driving events during the protracted time period being determined to be non-compliant operation.

In accordance with an embodiment, the control logic 232 stored in the memory device may include driving trend detection logic 275 that, when executed by the processor, detects trends in a driver's operation of one or more vehicles over a protracted time period. The protracted time period may include several separate driving trips, and may cover several days, weeks, or months. The driving trend detection logic 275 may analyze the set of event data based on a trend detection model comprising one or more of a functional regression model, a linear fit model and/or a polynomial fit model to generate the trend detection result. In accordance with an example embodiment, the fit may use the event rates per time to determine whether an increase to an unsafe level is occurring and/or is expected to occur. In accordance with an example embodiment, the fit may use the event rates per distance to determine whether an increase to an unsafe level is occurring and/or is expected to occur. A minimum number of trips is set as a minimum threshold quantity of trips required to produce reliable trend determinations and one or more thresholds are therefore set.

In accordance with an embodiment, the control logic 232 stored in the memory device may further include driver performance rating logic 276 that, when executed by the processor, determines a driver performance rating of the driver's operation based on the trend detection result. In accordance with an embodiment, the, trend detection has the favorable property of short-term noise removal while revealing long-term changes. Advantageously, therefore, the system in accordance with an example embodiment, obtains a noise-reduced estimate of the driver's current performance rating, with this having lower day to day fluctuation than the raw daily measurements.

In accordance with a further embodiment, the control logic 232, 232′ stored in the memory device may further include driver coaching logic 279, 279′ that, when executed by the processor, generates a driver coaching signal representative of a driving instruction based on one or more of the determined driver performance rating and/or a degree of agreement between the one or more of the functional regression model, the linear fit model and/or the polynomial fit model and the set of event data. In an example embodiment, the driving assessment system 200 includes an annunciator 264, 266 operatively coupled with the processor. The processor is configured to execute the driver coaching logic to annunciate the driving instruction to the driver via the annunciator.

In accordance with a further embodiment, the control logic 232 stored in the memory device may further include incident prediction control logic 277, that, when executed by the processor, determines a driving incident prediction by determining an imminent crossing of a threshold resulting from fitting a trend detection model to the set of event data with a predetermined threshold setting represented by the incident threshold data stored in the memory device. This driving incident prediction control logic is operative to flag a high likelihood of an event occurring or occurring too frequently and therefore at an unacceptable rate.

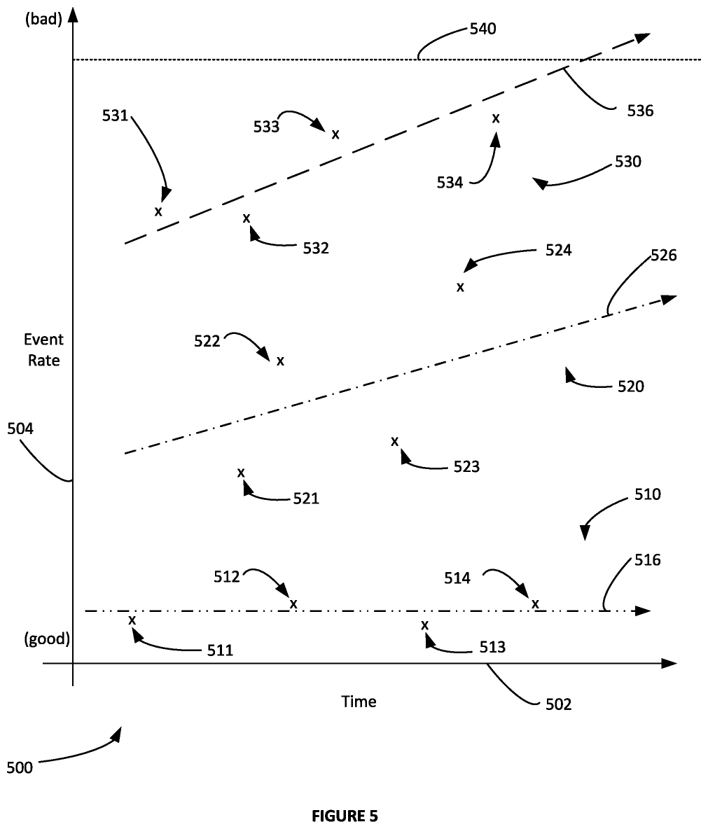

FIG. 5 is a graph 500 illustrating driver assessment in accordance with an embodiment. In the example, there (3) different drivers are assessed to help describe the embodiments. The graph 500 includes a time axis 502 with time increasing to the right as viewed in the Figure, and an event rate axis 504 with the event rate increasing to the top as viewed in the Figure, wherein the event rate may be in units of events per distance unit and/or events per time unit. It is to be appreciated that high event rates may be viewed as “bad” driving, and that low event rates may be viewed as “good” driving and, accordingly, the graph 500 is labeled accordingly. The event rates are determined in accordance with an example embodiment, for whole trips. It is to be appreciated, however, that the event rates may be determined in accordance with further example embodiments based on other criteria including and without limitation based on time dependent criteria including for example based on hour-long blocks within a trip. The former corresponds to trend detection over a period covering multiple trips, whereas the latter corresponds to trend detection over a subdivided period covering a single trip.

A first set of event data for a first driver is shown generally at 510, wherein the first set of event data 510 includes event data items 511-514. Each of the data items 511-514 represents events that were detected and stored in the event object storage as described above during separate driving trips. The event data items 511-514 therefore represent driving events that were detected and stored during separate driving trips spanning the protracted time period shown on the time axis 502. In accordance with an example embodiment, the event data items 511-514 represent driving events that were detected and stored during sufficiently many separate driving trips spanning the protracted time period shown on the time axis 502, wherein the sufficiency of the quantity or number of driving trips is selectable by the user, system administrator 162, and/or the fleet manager 160. The set of event data items 511-514 are analyzed by the driving assessment system 200 based on a trend detection model to generate a trend detection result. In the example shown, a straight line model is fit to the event data items 511-514 to generate a straight line vector 516. In an embodiment, the trend detection result is the straight line vector 516 itself. In another embodiment, the trend detection result is the slope of the straight line vector 516. In yet another embodiment, the trend detection result is a degree of agreement between the straight line model is fit to the event data items 511-514. In yet still another embodiment, the trend detection result is a combination of any one or more of the above trend detection results.

A general assessment of the driver performance rating for the first driver is as a “good” driver. The first driver starts at a low, good, event rate and nearly always stays there. There are minor deviations over time, but a straight line 516 generally fits his rate versus time history well. This is often the case for (professional) fleet drivers, whose performance is often unvarying, though each driver may be at different levels. The driving assessment system 200 may summarize his performance stability with a high R-squared value (so a line fits the data well). Furthermore, as he has sufficiently many data points, the driving assessment system 200 may assign a high degree of belief to our judgement that the first driver drives consistently and excellently well. If his event rate is lower than most of his cohort, he is among the best drivers.

A second set of event data for a second driver is shown generally at 520, wherein the second set of event data 520 includes event data items 521-524. Each of the data items 522-528 represents events that were detected and stored in the event object storage as described above during separate driving trips. The event data items 521-524 therefore represent driving events that were detected and stored during separate driving trips spanning the protracted time period shown on the time axis 502. In accordance with an example embodiment, the event data items 521-524 represent driving events that were detected and stored during sufficiently many separate driving trips spanning the protracted time period shown on the time axis 502, wherein the sufficiency of the quantity or number of driving trips is selectable by the user, system administrator 162, and/or the fleet manager 160. The set of event data items 521-524 are analyzed by the driving assessment system 200 based on a trend detection model to generate a trend detection result. In the example shown, a straight line model is fit to the event data items 521-524 to generate a straight line vector 526. In an embodiment, the trend detection result is the straight line vector 526 itself. In another embodiment, the trend detection result is the slope of the straight line vector 526. In yet another embodiment, the trend detection result is a degree of agreement between the straight line model is fit to the event data items 521-524. In yet still another embodiment, the trend detection result is a combination of any one or more of the above trend detection results.

A general assessment of the driver performance rating for the second driver is as a “mediocre” driver. The second driver does not drive as well as the first driver, with her trip event rates nearly always over those of the first driver. Furthermore, her performance is trending to worse, and furthermore, she is inconsistent with wide variations from the central trend line 526. This is reflected in her lower goodness of fit R-squared value. Perhaps she, with her high variability in performance should not be assigned to dangerous or difficult routes. The driving assessment system 200 may characterize the second driver as showing inconsistent performance. The driving assessment system 200 cannot state with any confidence that a linear model reflects her performance well, and thus the driving assessment system 200 does not extrapolate to any prediction from this excessively variable data. Coaching is indicated and perhaps driving support for this second driver.

A third set of event data for a third driver is shown generally at 530, wherein the third set of event data 530 includes event data items 531-534. Each of the data items 532-538 represents events that were detected and stored in the event object storage as described above during separate driving trips. The event data items 531-534 therefore represent driving events that were detected and stored during separate driving trips spanning the protracted time period shown on the time axis 502. In accordance with an example embodiment, the event data items 531-534 represent driving events that were detected and stored during sufficiently many separate driving trips spanning the protracted time period shown on the time axis 502, wherein the sufficiency of the quantity or number of driving trips is selectable by the user, system administrator 162, and/or the fleet manager 160. The set of event data items 531-534 are analyzed by the driving assessment system 200 based on a trend detection model to generate a trend detection result. In the example shown, a straight line model is fit to the event data items 5321-5324 to generate a straight line vector 536. In an embodiment, the trend detection result is the straight line vector 536 itself. In another embodiment, the trend detection result is the slope of the straight line vector 536. In yet another embodiment, the trend detection result is a degree of agreement between the straight line model is fit to the event data items 531-534. In yet still another embodiment, the trend detection result is a combination of any one or more of the above trend detection results.

A general assessment of the driver performance rating for the third driver is as a “bad” driver. The third driver is not a good driver to start with and is getting worse with time as can be seen from the graph 500. Furthermore, arising from upward moving points, a confirmed trend can be seen reaching toward critical levels. As there are sufficiently many points, and the third driver is consistent therein as reflected in a high R-squared value, the driving assessment system 200 characterizes his performance as a mediocre driver who is consistently getting worse. Given a sufficiently recent measured data point for the third driver, the driving assessment system 200 may predict via extrapolation that the third driver will exceed the critical event level established by a threshold level 540 in e.g. 10 days. If his event rate is higher than most of his cohort, he is among the worst drivers. If he has a steadily bad (high) event rate, he is a bad driver, in need of coaching or driving support.

In accordance with an embodiment, the driving assessment system 200 having a significant trend with a high R-squared or other goodness of model fit value and sourced from a sufficient quantity of data points, wherein the most recent point was not long ago, may extrapolate forward (though not too far) to determine his expected future performance. This future performance may reach a critical level, in which case action may need to be taken, e.g. by coaching being given before the threshold level is breached.

It is to be appreciated that the driving assessment system 200 also ranks the drivers when more than single drivers are being assessed, such as in a fleet application, or the like. The driving assessment system 200 identifies the best (first driver), the worst (third driver), the excessively variable (second driver), and the predicted to be critically dangerous drivers (third driver). The identification and prediction are performed in accordance with an example embodiment by fitting a model to driver performance over time, examining the number of data points, their degree of agreement with the model, the recency of the data points, and the drivers' relation to their cohort. It is to be appreciated that although a functional regression model, a linear fit model and/or a polynomial fit model is applied to predetermined event types of the driving events, other trend detection models may be used as necessary or desired.

In accordance with an embodiment, the driving assessment system 200 may consider other time periods, for instance within individual trips, looking to see if a trend toward excessively many events exists. A warning may be given to the driver if this is the case.

In accordance with an embodiment, the driving assessment system 200 may also consider the event mixture that drivers produce over time. For instance, a particular driver may increasingly unreliably judge distance as the time into a drive increases. That is, the driving assessment system 200 may apply a trend detection model by event type, within individual and across multiple drives. If too many events of a particular type start to or are predicted to occur, the driving assessment system 200 may take countermeasures, such as initiating earlier warnings, adding pre-warnings, recommending lowered speeds, modulating the commanded brake pressure, etc, and thereby maintain safety.

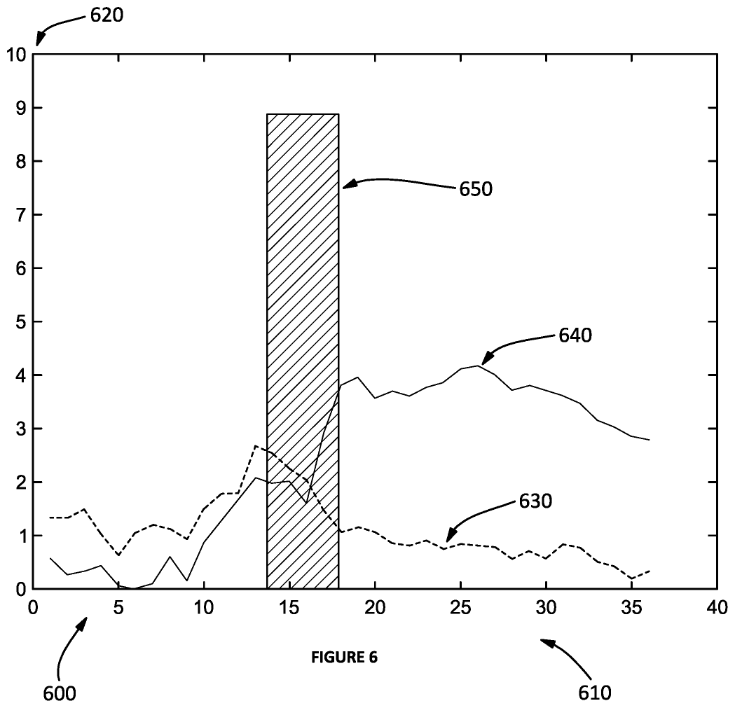

FIG. 6 is a graph 600 illustrating driver assessment in accordance with an embodiment. Turning now to that Figure and in accordance with an example embodiment, driver performance ranking is performed in order of highest (combined) rate (or score) to lowest value. The score calculation that is determined permits a combination of different event rates and types by normalizing the possibly widely different event rates to the same or a common scale. FIG. 6 shows the conversion of event rate(s) to a driver performance score as described herein. A time axis 610 represents in the example embodiment months of the drivers traveling with vehicles. The driver performance 620 represents performance scores of the drivers for the time period as shown. A first curve 630 represents in the example the combined scores of drivers of a first fleet, and the second curve 640 represents in the example the combined scores of drivers of a second fleet. As can be seen, coaching is indicated for the drivers of the first fleet as shown by the decrease in performance scoring during the transition period 650. Both the type(s) of event causing the decreased score and the driver(s) exhibiting this reduced performance are identified to then targetedly improve the fleet average.

In accordance with an embodiment, a (rate and/or score) threshold may be set to identify the problem drivers, by event or grouped event type.

A threshold in accordance with an embodiment may be a desired target performance, an observed unacceptable value, a percentile of the fleet's performance (e.g. the fleet's 10^{th} percentile event rate for distance keeping shall not exceed 1 event per 1000 kilometers). This threshold is a rate or its equivalent score. Typical scoring scheme in accordance with an example embodiment is linear, wherein:

$$score = 10 - {10}^{*} ( event rate ) / ( worst - case event rate )$$

In accordance with an embodiment, the above formula gives a score of zero when the event rate is equal to the worst-case event rate.

A score of 10 only results if no events (and hence a zero-event rate) have occurred over the time period of interest. Values other than 10 indicating zero event-rate operation are also possible. Event rates may also be converted into their inverse distance or time between events counterparts, where small distance between event values correlate with high events per distance values, and likewise for time-based measures.

By keeping the worst case event rate value at some setpoint, the system in accordance with an embodiment permits comparison of scores over time. If the worst case event rate is taken from the worst performing fleet (of a plurality of fleets), then the other fleets may compare their performance against this shared reference value. The worst case event rate may also be set by transportation policy, safety standards, insurance companies, or industry recommendations.

Individual event types may be scored individually, as above, and their scores then combined in a weighted fashion. The weights typically sum to one, and the combined score is then:

Sum of(weight*event rate)

For all event types in the combination, if the weights do not sum to one, then the sum above is divided in accordance with an embodiment by the sum of the weights, i.e. normalized.

Combinations may be usefully made to separate the different axes of vehicle behavior. In accordance with an embodiment, there are lateral events (LDW, xLDW, lane change without turn signal), longitudinal events (XBR, FCW, CMB, ESP, etc), and speed events (speeding, excessive curve speed, speed adaptation time).

A driver may thus be scored, ranked, and/or identified in accordance with an embodiment as good or bad, in current or imminent need of coaching or praise, etc, via the single or combined event scores.

A comparison of a customer's fleet with the scores of other fleets is also beneficial in understanding how good or bad other drivers can be, whether there are seasonal effects, and whether a general improvement of deterioration is happening. For instance, a reference group of fleets has an event rate time history shown in the curve 640. And a single customer's fleet shown in the curve 630 may initially be better but then worsen, both relative to its initial value and other fleets. The operator of this worsening fleet may then understand that improved performance is possible and that coaching is indicated for at least some of the drivers in his fleet.

It is to be appreciated that the graph 600 only shows the mean value over time. However, in accordance with a further example embodiment, the system includes one or more calculations of error bars or one or more ‘envelopes’ around a mean. This error bar is in accordance with example embodiments the standard deviation of the scores for drivers from the mean, quartile values, or the minimum and maximum score the drivers within a fleet. When these are included above, it is apparent that there is no overlap between the drivers performance in curve 630 and the drivers of curve 640, which in turn encourages more coaching, hiring of better drivers, removal of the worst drivers from the worsening fleet (who drag the average performance down), etc.

Because the above graph 600 compares fleet averages, and the zero reference rate is the worst single month's event rate, the system of the present disclosure may and very likely will have drivers who are worse than the zero reference rate. For instance, a school class may have a C average grade in a range of A-F, giving a score of zero, but there are still students with grades of D and F. These would map to negative score values above, but for visual simplicity, the showing is limited to zero and/or perhaps a ‘catchment zone’ below the axis.

It is to be appreciated that although the first curve 630 shown in FIG. 6 represents in the example the combined scores of drivers of a first fleet, and although the second curve 640 represents in the example the combined scores of drivers of a second fleet, the plot 600 may alternatively graph and the system may analyze scores of drivers of fleets with regard to event type such as for example with regard to any of the event types described above including for example lateral events such as for example lane keeping events, longitudinal events such as distance keeping or excessive braking episodes, and speed related events such as driving in excessive of posted speed limits.

It is to be appreciated that the plot 600 may graph and the system may analyze scores of drivers of fleets with regard to any combination of event type such as for example with regard to combinations of any of lateral events such as for example lane keeping events, longitudinal events such as distance keeping or excessive braking episodes, and speed related events such as driving in excessive of posted speed limits. This separation into event type groups makes problem areas clearer than an overall combined single score.

It is to be appreciated that the plot 600 may graph and the system may analyze scores of drivers of fleets with regard to scores of drivers of fleets with regard to specific events such as for example with regard to any of the events described above including for example lane keeping events, distance keeping events or excessive braking episodes, and excessive speed events.

It is to be appreciated that the plot 600 may graph and the system may analyze scores of drivers of fleets with regard to scores of drivers of fleets with regard to any combination specific events such as for example with regard to combinations of any of lane keeping events, distance keeping events or excessive braking episodes, and excessive speed events.

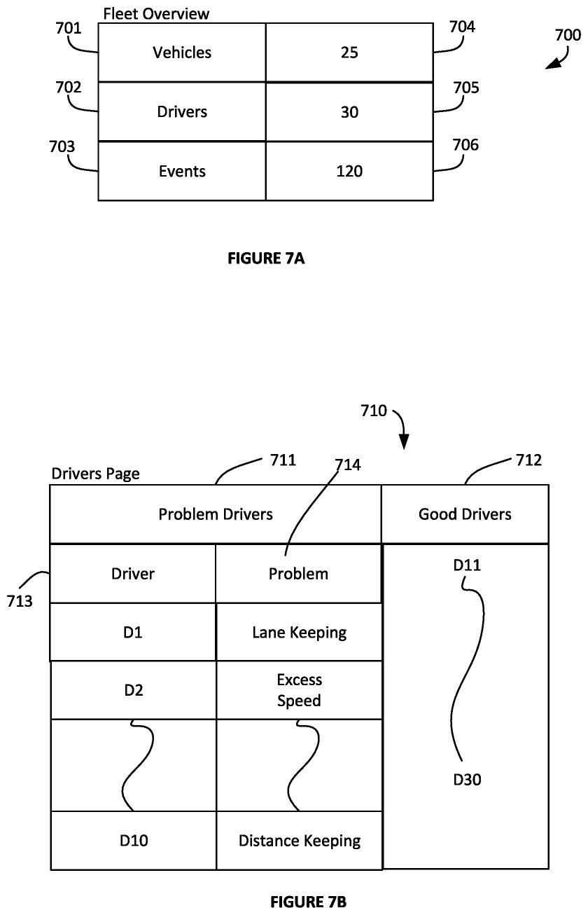

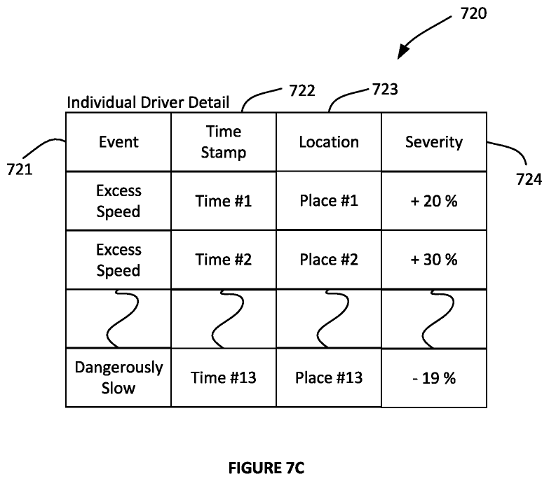

FIG. 7A is an example graphical user interface screen showing a fleet overview landing page 700 view generated by the driving assessment system 200 executing the control logic according to an example embodiment. As shown, the fleet overview landing page 700 provides a fleet overview to the fleet manager 160 when viewing the fleet overview landing page 700 locally at a terminal in communication with the system server 140. The landing page 700 includes a cell 701 that identifies the fleet as having vehicles, and a corresponding cell 704 that indicates that the fleet has 25 vehicles. Fleets with different vehicle types, e.g. with short-haul, local delivery, vehicles as well as long-haul vehicles may show the quantity of each separately, as well as then the trends within these separated vehicle groups. Similarly, the landing page 700 includes a cell 702 that identifies the fleet as having drivers, and a corresponding cell 705 that indicates that the fleet has 30 drivers. Also similarly, the landing page 700 includes a cell 703 that identifies the fleet as having some driving events over the course of the time query that generated the landing page 700, and a corresponding cell 706 that indicates that the fleet had 120 driving events over the time query.

FIG. 7B is an example graphical user interface screen showing a drivers overview page 710 view generated by the driving assessment system 200 executing the control logic 232 according to an example embodiment. The drivers overview page 710 is generated by the driving assessment system 200 based on a selection by the operator 160 of the drivers column of the landing page 700, whereupon the driving assessment system 200 automatically generates a list of problem drivers and a list of good drivers as represented in columns 711 and 712 of the drivers overview page 710, respectively. The list of problem drivers is further automatically refined by the driving assessment system 200 executing the control logic 232 to provide a list of problem driver identifications 713, and their respective particular problems 714. These problems are typically individual event types or groups of event types (e.g. distance management or keeping, which includes Forward Collision Warnings, Collision Mitigation Braking, Distance Alerts, etc.). As illustrated, driver D1 has lane keeping issues, driver D2 has speeding issues, and driver D10 has distance keeping issues. That is, the driving assessment system 200 executing the control logic 232 determined based on the analysis described above of the event data relating to driver D1, that he has lane keeping issues. Similarly, the driving assessment system 200 executing the control logic 232 determined based on the analysis described above of the event data relating to driver D2, that he has speeding issues. Further similarly, the driving assessment system 200 executing the control logic 232 determined based on the analysis described above of the event data relating to driver D10, that he has distance keeping issues. The particular driving issues of drivers D3-D9 are not shown for simplification of the disclosure. The list of good drivers 712 identifies drivers D11-D30 as being good drivers. These may be listed in ranked order, this perhaps furthermore divided into categories (e.g. distance keeping, speed management, etc).

FIG. 7C is an example graphical user interface screen showing a selected driver's overview page 720 view generated by the driving assessment system 200 executing the control logic 232 according to an example embodiment. The selected driver's overview page 720 is generated by the driving assessment system 200 based on a selection by the operator 160 of a particular driver from the drivers overview page 710, whereupon the driving assessment system 200 automatically generates a list of problems that the selected driver had as represented in the Event column 721. In the example the driver D2 was selected and as can be seen, driver D2 has excess speed issues. The selected driver's overview page 720 also includes a column 722 that provides time stamps to each observed event as obtained from the event objects stored in the event object storage relating to the driver D2, a further column 723 that provides location information to each observed event, and a still further column 724 that provides a severity indication to each observed event. Videos of the individual events may be made available by clicking on hyperlinks embedded in the driver's overview table. The ordering of the events may be by time, by severity, by location, by representativeness, etc.

Tracking of coaching may also be provided. For instance, the system may store which drivers most need coaching (this done by ordering in the drivers overview page), the date on which they are coached and by whom, etc. In accordance with an example embodiment, the system may be configured to selectively then also look for a trend toward improvement after coaching has taken place. The system may report any one or more of that improvement has occurred after coaching has taken place, that improvement has not occurred after coaching has taken place, and/or a level of improvement that has occurred after coaching has taken place. A subsequently worsened performance an initial improvement may trigger secondary, reinforcing coaching.

The example graphical user interface screens 700, 712, and 720 are useful to the fleet managers 160 in making staffing decisions, reward and/or disciplinary decisions, and in issuing or making driving coaching recommendations to the selected fleet drivers.

It is to be understood that other embodiments will be utilized and structural and functional changes will be made without departing from the scope of the present invention. The foregoing descriptions of embodiments of the present invention have been presented for the purposes of illustration and description. It is not intended to be exhaustive or to limit the invention to the precise forms disclosed. Accordingly, many modifications and variations are possible in light of the above teachings. It is therefore intended that the scope of the invention be limited not by this detailed description.

1. A system for assessing a driver's operation of a vehicle over a selected time period and automatically providing a driver performance rating of the driver's operation, the system comprising:
a control circuit comprising:
a memory device;
control logic stored in the memory device; and
a processor operatively coupled with the memory device, the processor being configured to execute the control logic to:
receive a set of event data representative of driving events comprising occurrences of operation of the vehicle during the selected time period being determined to be non-compliant operation;
analyze the set of event data based on a trend detection model to generate a trend detection result;
determine a driver performance rating of the driver's operation based on the trend detection result; and
generate based on the determined driver performance rating a driver performance rating control signal for use in controlling one or more functional aspects of the vehicle.

2. The system according to claim 1, wherein the control circuit operates to deliver the driver performance rating control signal to an electronic control unit (ECU) of the vehicle to thereby control one or more functional aspects of the vehicle based on the determined driver performance rating.

3. The system according to claim 1, wherein the processor is configured to execute the control logic to:
receive the set of event data comprising event rate data representative of rates of occurrences of the driving events determined to be the non-compliant operation during each of a plurality of separate driving trips spanning the selected time period;
analyze the event rate data based on the trend detection model to generate the trend detection result; and
determine the driver performance rating of the driver's operation based on the trend detection result.

4. The system according to claim 1, wherein the processor is configured to execute the control logic to:
receive the set of event data comprising event type data representative of types of the driving events during the selected time period being determined to be non-compliant operation;
analyze the event type data based on the trend detection model to generate the trend detection result; and
determine the driver performance rating of the driver's operation based on the trend detection result.

5. The system according to claim 1, wherein the processor is configured to execute the control logic to:
receive the set of event data comprising event type data representative of types of the driving events during the selected time period being determined to be non-compliant operation;
analyze the event type data based on the trend detection model to generate the trend detection result; and
determine the driver performance rating of the driver's operation based on the trend detection result.

6. The system according to claim 1, wherein the processor is configured to execute the control logic to:
analyze the set of event data based on a trend detection model comprising one or more of a functional regression model, a linear fit model and/or a polynomial fit model to generate the trend detection result; and
determine the driver performance rating of the driver's operation based on the trend detection result.

7. The system according to claim 6, wherein the processor is configured to execute the control logic to analyze the set of event data using the one or more of the functional regression model, the linear fit model and/or the polynomial fit model applied to predetermined event types of the driving events comprising the occurrences of operation of the vehicle determined to be non-compliant operation.

8. The system according to claim 6, further comprising:
driver coaching logic stored in the memory device,
wherein the processor is configured to execute the driver coaching logic to:
generate a driver coaching signal representative of a driving instruction based on one or more of the determined driver performance rating and/or a degree of agreement between the one or more of the functional regression model, the linear fit model and/or the polynomial fit model and the set of event data, wherein the driving instruction of the driver coaching signal informs the driver recommended control of the operation of the vehicle based on the determined driver performance rating.

9. The system according to claim 6, further comprising:
an annunciator operatively coupled with the processor,
wherein the processor is configured to execute the driver coaching logic to annunciate the driving instruction to the driver via the annunciator.

10. The system according to claim 6, further comprising:
incident prediction logic stored in the memory device; and
incident threshold data stored in the memory device,
wherein the processor is configured to execute the incident prediction logic to determine a driving incident prediction by determining an imminent intersection of a trajectory or event rate level resulting from fitting the trend detection model to the set of event data with a predetermined threshold setting represented by the incident threshold data stored in the memory device.

11. A method for assessing a driver's operation of a vehicle over a selected time period and automatically providing a driver performance rating of the driver's operation, the method comprising:
receiving a set of event data by a control circuit comprising a memory device, control logic stored in the memory device, and a processor operatively coupled with the memory device, wherein the set of event data is representative of driving events comprising occurrences of operation of the vehicle during the selected time period being determined to be non-compliant operation;
analyzing by the processor executing control logic stored in the memory device the set of event data based on a trend detection model to generate a trend detection result;
determining by the processor executing control logic stored in the memory device a driver performance rating of the driver's operation based on the trend detection result; and
generating by the processor executing control logic stored in the memory device based on the determined driver performance rating a driver performance rating control signal for use in controlling one or more functional aspects of the vehicle.

12. The method according to claim 11, further comprising:
delivering the driver performance rating control signal to an electronic control unit (ECU) of the vehicle to thereby control one or more functional aspects of the vehicle based on the determined driver performance rating.

13. The method according to claim 11, further comprising:
receiving the set of event data comprising event rate data representative of rates of occurrences of the driving events determined to be the non-compliant operation during each of a plurality of separate driving trips spanning the selected time period;
analyzing by the processor executing control logic the event rate data based on the trend detection model to generate the trend detection result; and
determining by the processor executing control logic the driver performance rating of the driver's operation based on the trend detection result.

14. The method according to claim 11, further comprising:
receiving the set of event data comprising event type data representative of types of the driving events during the selected time period being determined to be non-compliant operation;
analyzing by the processor executing control logic the event type data based on the trend detection model to generate the trend detection result; and
determining by the processor executing control logic the driver performance rating of the driver's operation based on the trend detection result.

15. The method according to claim 11, further comprising:
receiving the set of event data comprising event type data representative of types of the driving events during the selected time period being determined to be non-compliant operation;
analyzing by the processor executing control logic the event type data based on the trend detection model to generate the trend detection result; and
determining by the processor executing control logic the driver performance rating of the driver's operation based on the trend detection result.

16. The method according to claim 11, further comprising:
analyzing by the processor executing control logic the set of event data based on a trend detection model comprising one or more of a functional regression model, a linear fit model and/or a polynomial fit model to generate the trend detection result; and
determining by the processor executing control logic the driver performance rating of the driver's operation based on the trend detection result.

17. The method according to claim 16, further comprising analyzing by the processor executing the control logic the set of event data using the one or more of the functional regression model, the linear fit model and/or the polynomial fit model applied to predetermined event types of the driving events comprising the occurrences of operation of the vehicle determined to be non-compliant operation.

18. The method according to claim 16, further comprising:
generating a driver coaching signal by the processor executing driver coaching logic stored in the memory device, wherein the driver coaching signal is representative of a driving instruction based on one or more of the determined driver performance rating and/or a degree of agreement between the one or more of the functional regression model, the linear fit model and/or the polynomial fit model and the set of event data, wherein the driving instruction of the driver coaching signal informs the driver recommended control of the operation of the vehicle based on the determined driver performance rating.

19. The method according to claim 16, further comprising:
executing the driver coaching logic to annunciate by an annunciator operatively coupled with the processor the driving instruction to the driver.

20. The method according to claim 16, further comprising:
determining by the processor executing incident prediction logic stored in the memory device a driving incident prediction by determining an imminent intersection of a trajectory or event rate resulting from fitting the trend detection model to the set of event data with a predetermined threshold setting represented by the incident threshold data stored in the memory device.
